(19) United States
(12) Patent Application Publication
(10) Pub. No.: US 2024/0328539 A1
(43) Pub. Date: Oct. 3, 2024

(54) CONFIGURABLE PIPE AND CONDUIT SUPPORT

(71) Applicants: Paul Laurent Artigues, Auburn, GA (US); Robert Rue Emrich, Lindale, TX (US)

(72) Inventors: Paul Laurent Artigues, Auburn, GA (US); Robert Rue Emrich, Lindale, TX (US)

(21) Appl. No.: 18/623,998

(22) Filed: Apr. 1, 2024

Related U.S. Application Data
(60) Provisional application No. 63/493,766, filed on Apr. 2, 2023.

(51) Int. Cl. F16L 3/127; F16L 3/137; F16L 3/22

(52) U.S. Cl. CPC F16L 3/127; F16L 3/137; F16L 3/221

(57) ABSTRACT

A mechanism for the support or suspension of a tubular member having a pair of mounting brackets including pivotally mounted receivers to threadingly engage a pair of threaded rods, a pair of threaded rods, a pair of supporting shoes, and a circumferential clamping mechanism to bind the shoes around the tubular member it is supporting. The mounting brackets may be configured to engage and rigidly clamp to universal strut channel. Threaded rod of desired length is installed at one end to the pivotally mounted receiver of the bracket and the other end to the support shoe. Fine elevation adjustment is achieved by adjusting the engagement between the threaded rods and shoes or adjustment of the span between brackets. The mechanism offers broad installation flexibility while minimizing supply side costs associated with packaging, inventory, warehousing, and transportation.

### BACKGROUND OF THE INVENTION

### I. Field of the Invention

The present invention relates generally to the field of structural support. More particularly the present invention relates to the suspension and support of pipe or conduit.

Devices for the support and suspension of pipe and conduit are used extensively in fluid and electrical distribution systems. Many variations of hanger straps and cradles have been devised and many utilize structural members known as universal strut channel. The variations that mount in close proximity to structural members such as channel inherently restrict motion laterally as well as vertically. Pipe supports and hangers that provide more freedom in setting of elevation tend to lack lateral support and are often severely limited in range as a result. There exists a need for a pipe support that accommodates a broader range of elevation adjustment while still maintaining lateral stability.

### II. Description of the Related Art

The field of design related to pipe and conduit support is well established with many variations of common styles. One such style is a saddle strap and yoke strap arrangement for hanging a pipe. The yoke for mounting to a rod, screw, or bolt, and the saddle to cradle a pipe. Patents to Duhamel (U.S. Pat. No. 3,051,424), Denis (U.S. Pat. No. 2,714,497), Hirt (U.S. Pat. No. 3,652,045), Habuda (U.S. Pat. No. 4,019,705), Weiland (U.S. Pat. No. 4,019,706), Banks (U.S. Pat. No. 4,440,369), Harris (U.S. Pat. No. 5,219,427), Carbonare (U.S. Pat. No. 6,138,960), Connolly (U.S. Pat. No. 7,284,728), Lange et al. (U.S. Pat. No. 9,903,524) describe such an arrangement. A slight variation on this are the integrated yoke and strap disclosed in patents to Manasek (U.S. Pat. No. 1,963,908), and Hofle (U.S. Pat. No. 5,193,769). Patent to Roth (U.S. Pat. No. 10,746,324) discloses a variant that includes lateral seismic bracing.

Pedestal style bases with rigid saddles for pipe support are described in patents to Di Laura (U.S. Pat. No. 3,809,348), Leitch et al. (U.S. Pat. No. 4,445,656), Curtis (U.S. Pat. No. 4,502,653), Brown (U.S. Pat. No. 5,906,341), and ball et al. (U.S. Pat. No. 10,774,951). Patent to Schoenky (U.S. Pat. No. 5,110,073) describes a pedestal style base with a flange mounting plate for support.

Patent to Atkinson (U.S. Pat. No. 2,567,463) teaches of the use of U-bolts and channel to secure a pipe to a beam.

Patents to Bach (U.S. Pat. No. 2,375,513), Fuss (U.S. Pat. No. 2,880,949), Reiland (U.S. Pat. No. 2,944,313), Kindorf (U.S. Pat. No. 3,145,962), Clark (U.S. Pat. No. 3,226,069), Lytle (U.S. Pat. No. 3,522,921), Madej (U.S. Pat. No. 4,417,711), Howard (U.S. Pat. No. 4,708,554), Cusic (U.S. Pat. No. 5,141,186), Todd et al. (U.S. Pat. No. 5,165,628) all describe brackets designed to secure pipes or conduit to strut channel.

Patent to Whipple (CA 2564323) and patent to Zhang et al. (U.S. Pat. No. 9,458,952) both describe clips for coupling rungs of strut channel to threaded rod providing the ability to hang pipes and conduit at different elevations in a trapeze fashion.

Patent to Ball et al. (U.S. Pat. No. 10,746,323) presents a pipe support with two pedestal bases and a means for adjusting the elevation of the pipe within a range defined by the length of the arms with integral jaws.

### BRIEF SUMMARY OF THE INVENTION

In its preferred embodiment, the present invention comprises a pair of bracket assemblies that each clamp to a strut channel with a cap screw and a channel nut. Each bracket assembly has a cylinder rotatable around its axis within its bracket. A threaded rod, of chosen length, is threaded into a cross drilled and tapped aperture in each cylinder and rigidly secured by tightening a hex nut against the cylinder. In the preferred embodiment of the pipe support, a nut and a support shoe are threaded onto the other end of each threaded rod and locked in position by backing the nut against the support shoe. In the preferred embodiment of the pipe support, two nuts are threaded onto the other end of each threaded rod about the aperture in the hanger shoe and the hanger shoe is locked in position by tightening the nuts. The support shoes or hanger shoes are clamped to the pipe or conduit using hose clamps or other clamping means thus binding the system together and providing a rigid triangulated support for the pipe or conduit. The system provides for great flexibility in course elevation parameter by giving choice in the length of threaded rod, and infinite fine adjustment of elevation by adjustment of the components about the threaded rods or the span of the brackets. While providing greater lateral support by virtue of the triangulated structure, the angles of triangulation may also be specified to allow for flex and thus thermal expansion in cases where a long vertical run of pipe leads up to the section supported. In applications that are subject to seismic loads, the pipe support of the present invention may reduce the quantity of supplemental bracing required. The method in which this is accomplished, as well as other features, advantages, and capabilities of the present invention will become apparent from the foregoing description taken in conjunction with the accompanying drawings illustrating the preferred embodiment of the invention.

### BRIEF DESCRIPTION OF THE DRAWINGS

The invention will be better understood when consideration is given to the following detailed description referencing the annexed drawings wherein. Like reference numerals have been assigned to relevant parts and are utilized throughout the drawings for clarity. The pipe support of the present invention is indicated by the numeral 101 and the pipe hanger of the present invention 102.

FIG. 1 is a perspective view of the pipe support.

FIG. 2 is a perspective view of the pipe hanger.

FIG. 3 is an isometric partially exploded view of the pipe support of FIG. 1.

FIG. 4 is an isometric partially exploded view of the pipe hanger of FIG. 2.

FIG. 5 is a perspective view illustrating the present invention in various sizes at different support elevations.

FIG. 6 is a perspective view illustrating an alternate embodiment of the pipe support.

FIG. 7 is a perspective view of a packaged pipe support.

### DESCRIPTION OF THE PREFERRED EMBODIMENTS

For a fuller understanding of the nature, application and function of the present invention, reference should be directed to the following detailed description taken in context with the accompanying drawings.

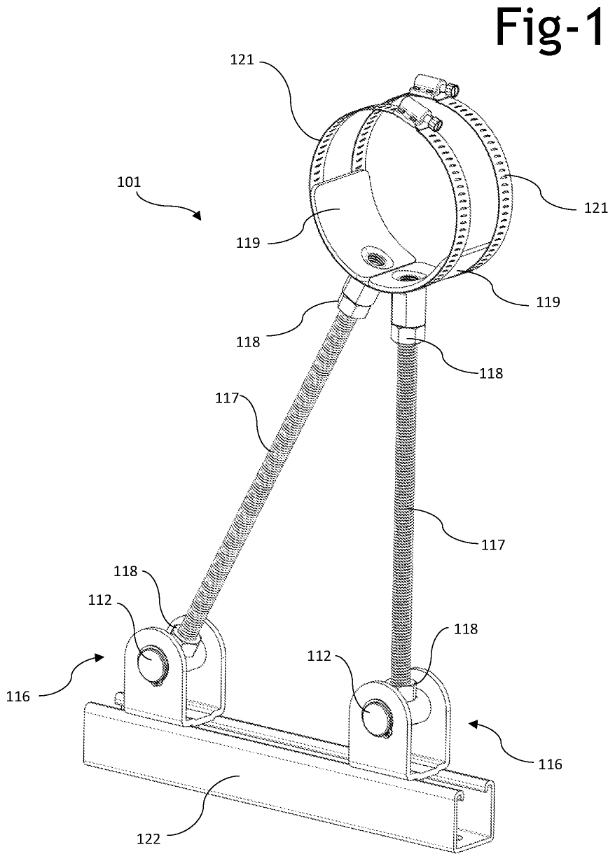

Referring first to FIG. 1 for a better understanding of the general construction and application of the preferred embodiment of the pipe support. A pair of bracket assemblies 116 are attached to a strut channel 122. Each bracket assembly 116 contains a cylinder 112, pivotally constrained and provisioned to accept a threaded rod 117 of a desired length. A nut 118 is run up on the threaded rod and the proximal end of the rod 117 is threaded into the cylinder 112. Attached to the distal end of the threaded rod 117 is another nut 118 and a support shoe 119. Fine adjustment of height may be accomplished by adjusting the thread engagement between threaded rod 117 and cylinder 112 or support shoe 119. Nuts 118 may be tightened against cylinders 112 and support shoes 119 to rigidly fix them with the threaded rod 117. Hose clamps 121 are installed to bind the support shoes 119 to a pipe (not shown). As a result of this binding, cylinders 112 are no longer free to rotate and the pipe is thus rigidly supported. Various elevations may be accommodated by the cut length of threaded rod 117 and various support angles for the threaded rod 117 may be employed. Furthermore, support shoes 119 may be configured to cradle any given pipe diameter or angular to fit multiple diameters, and threaded rod 117 may be of any diameter and thread pitch deemed appropriate.

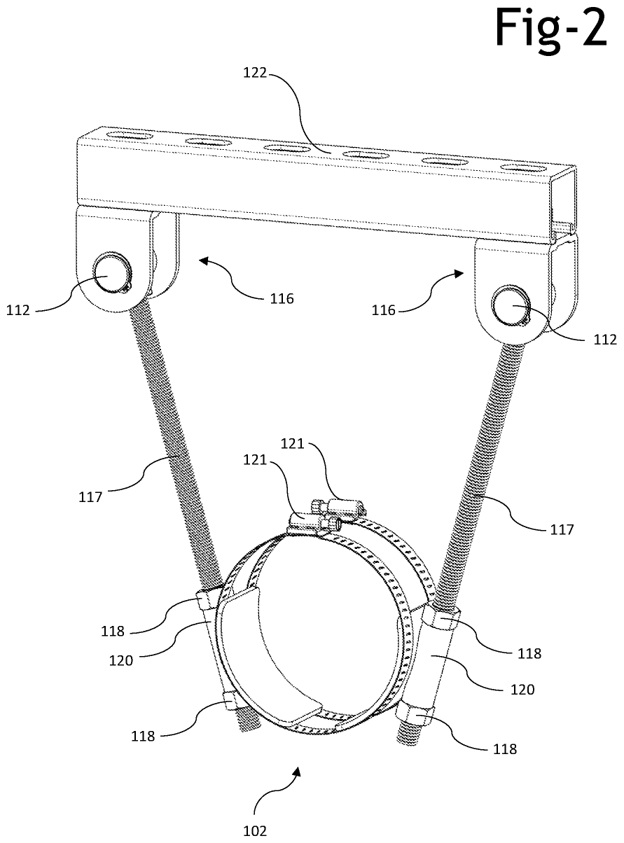

Referring now to FIG. 2 for a better understanding of the general construction and application of the preferred embodiment of the pipe hanger 102. A pair of bracket assemblies 116 are attached to a strut channel 122. Each bracket assembly 116 contains a cylinder 112, pivotally constrained and provisioned to accept a threaded rod 117 of a desired length. A nut 118 is run up on the threaded rod and the proximal end of the rod is threaded into the cylinder 112. Attached to the distal end of the threaded rod 117 is a hanger shoe 120. The support shoe 120 is retained and secured to the rod by two nuts 118. Fine adjustment of height may be accomplished by adjusting the thread engagement between threaded rod 117 and cylinder 112 or the nuts about hanger shoe 120, or by adjusting the span of bracket assemblies 116. Nuts 118 may be tightened against cylinders 112 and hanger shoes 120 to rigidly fix them with the threaded rod 117. Hose clamps 121 are installed to bind the hanger shoes 120 to a pipe (not shown). As a result of this binding, cylinders 112 are no longer free to rotate and the pipe is thus rigidly suspended. Various elevations may be accommodated by the cut length of threaded rod 117 and various support angles for the threaded rod 117 may be employed. Furthermore, hanger shoes 120 may be configured with an interior radius to cradle any given pipe diameter or angular to fit multiple diameters, and threaded rod 117 may be of any diameter and thread pitch deemed appropriate.

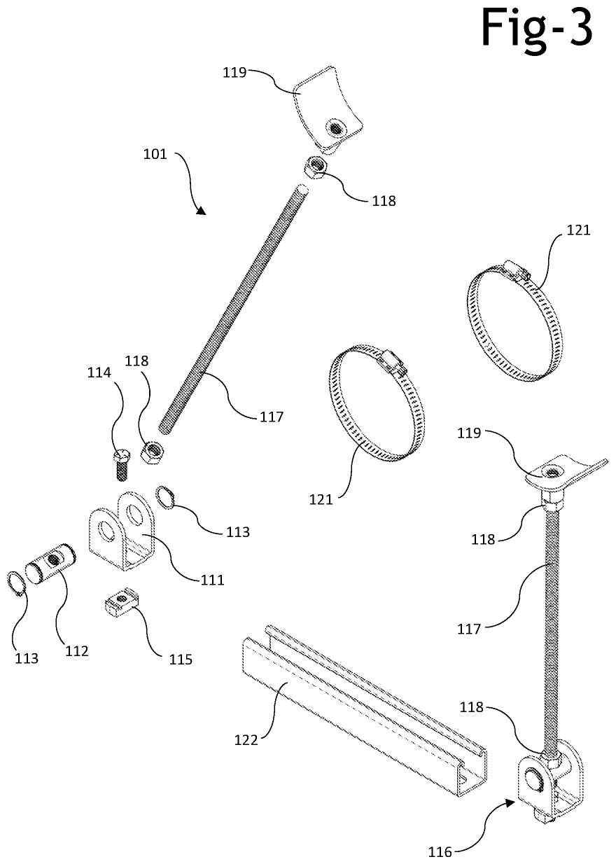

For a better understanding of the bracket assembly 116 and construction of the pipe support 101, reference is directed to FIG. 3 which is an isometric partially exploded view of the assembly shown in FIG. 1. The bracket assembly 116 comprises a bracket 111 designed to accept a cylinder 112 at one end and a bolt 114 and channel nut 107 for clamping to the strut channel 122 at its base. The cylinder 112 is cross bored and threaded to accept a threaded rod 117 and may be retained in the bracket 111 by external snap rings 113. The support shoe 119 may be threaded and securely locked in position on the rod 117 by tightening nut 118 against it. Hose clamps 121 are installed to bind the hanger shoes 120 to a pipe (not shown).

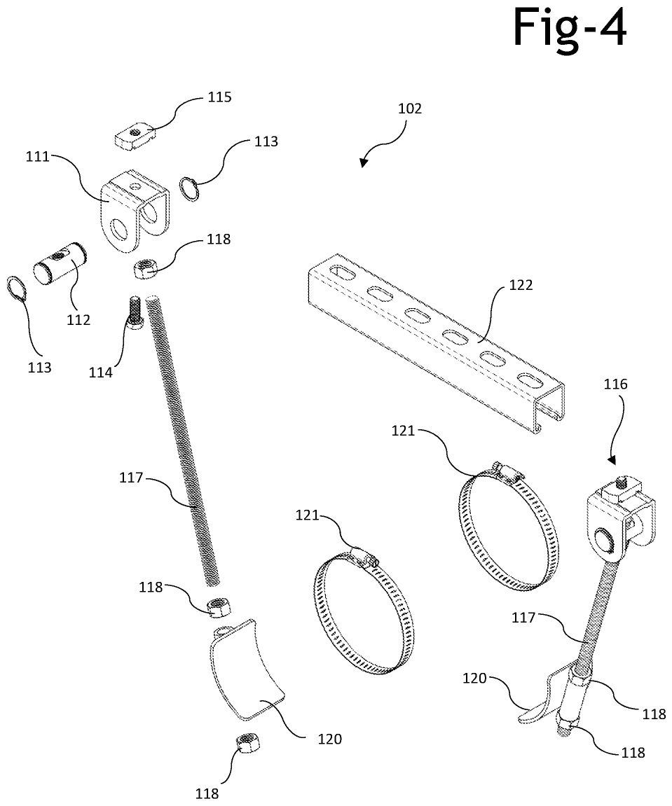

For a better understanding of the pipe hanger 102, reference is directed to FIG. 4 which is an isometric partially exploded view of the assembly shown in FIG. 2. The bracket assembly 116 comprises a bracket 111 designed to accept a cylinder 112 at one end and a bolt 114 and channel nut 107 for clamping to the strut channel 122 at its base. The cylinder 112 is cross bored and threaded to accept a threaded rod 117 and may be retained in the bracket 111 by external snap rings 113. The hanger shoe is designed to cradle the lower surface of the pipe and is affixed to the threaded rod 117 by a pair of nuts 118. Hose clamps 121 are installed to bind the hanger shoes 120 to a pipe (not shown).

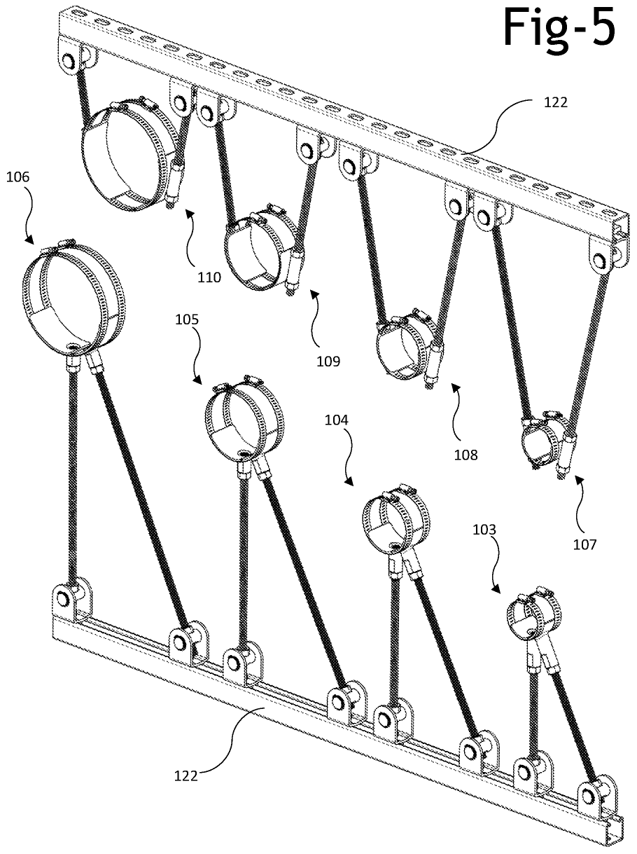

Referring now to FIG. 5 which is a perspective view of a sampling of pipe supports and pipe hangers of the present invention affixed to strut channel 122 and illustrating different diameters and different elevations. Examples shown are: 103, 107 for 2″ NPS pipe; 104, 108 for 3″ NPS pipe; 105, 109 for 4″ NPS pipe; 106, 110 for 6″ NPS pipe. It is obvious that these examples are for reference and that scaling of components may accommodate any given pipe diameter. While strut channel is the preferred substrate it should also be evident that the brackets may be mounted to any appropriate substrate.

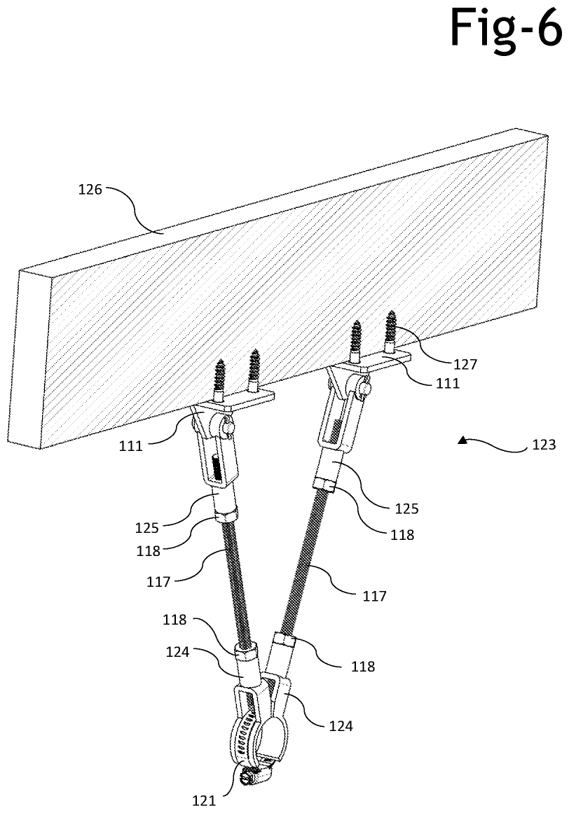

Directing reference to FIG. 6 which depicts another embodiment of the present invention. Brackets 111 may be secured to a joist 126 with screws 127. A clevis style rod receiver 125 is pivotally attached to the brackets 111 and a threaded rod 117 connects each receiver clevis 125 to a combination shoe 124. The combination shoe 124 is configured to cradle the pipe (not shown) whether in tension or compression. Nuts 118 bind receiver clevises 125, threaded rods 117, and combination shoes 124 together. A pipe clamp 121 binds the combination shoes 124 to the pipe (not shown) thus rigidly fixing the pipe and support in place.

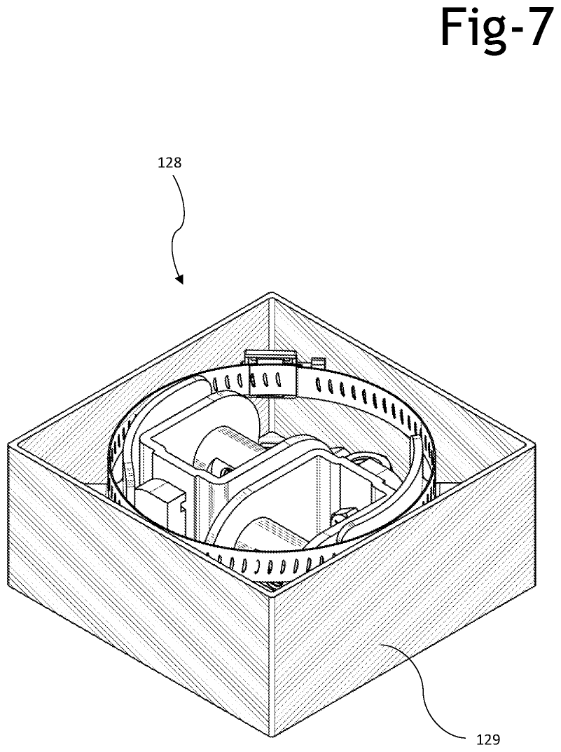

FIG. 7 illustrates the advantages of the pipe support and pipe hanger from the supply side perspective. As strut channel and threaded rod are common and readily available, only the components needed to complete construction are required to be included. This minimizes supply side costs associated with packaging, inventory, warehousing, and transportation. A component kit 128 may be packaged in a box 129 that is only slightly larger across than the diameter of the pipe it is to accommodate. Threaded rod and universal strut channel may be procured locally in quantity and length appropriate for the project, thus simplifying the installer's inventory by reducing combinations and affording broad installation flexibility.

Therefore, the foregoing is considered as illustrative of the principles of the present invention in its preferred embodiment. Further, various modifications may be made of the invention without departing from the scope thereof and it is desired, therefore, that only such limitations shall be placed thereon as are imposed by the prior art and which are set forth in the appended claims.

What is claimed is:

1. A mechanism for the support or suspension of a round tubular member, the mechanism comprising:
a pair of brackets, each having a mounting surface and at least one tab angled from said surface;
a pair of receivers pivotally mounted to said tab of said mounting brackets and provisioned to engage a threaded rod;
a pair of threaded rods;
a pair of shoes provisioned to cradle said round tubular member and engage said threaded rods; and
a circumferential clamping mechanism for the binding of said shoes to said tubular member.

2. A mechanism for the support or suspension of a round tubular member as claimed in claim 1, wherein said brackets are configured to engage and secure to universal strut channel.

3. A mechanism for the support or suspension of a round tubular member as claimed in claim 1, wherein said pivotally mounted receivers are cylindrical, cross bored, and threaded to engage said threaded rod.

4. A mechanism for the support or suspension of a round tubular member as claimed in claim 1, wherein said shoes have an internal radius corresponding to the outer diameter of the round tubular member being supported.

5. A mechanism for the support or suspension of a round tubular member as claimed in claim 1, wherein said circumferential clamping mechanism comprises a hose clamp.

6. A mechanism for the support or suspension of a round tubular member as claimed in claim 1, wherein said brackets are configured to be fastened to a substrate with screws or bolts.

7. A mechanism for the support or suspension of a round tubular member as claimed in claim 1, wherein said pivotally mounted receivers are clevis rod ends.
